(19) United States
(12) Patent Application Publication
(10) Pub. No.: US 2006/0161947 A1
(43) Pub. Date: Jul. 20, 2006

(54) Method and apparatus for customizing messaging within a cable system

(76) Inventors: Indra Laksono, Richmond Hill (CA); Paul Ducharme, Scarborough (CA)

Correspondence Address: GARLICK, HARRISON & MARKISON, LLP, P.O. BOX 160727, AUSTIN, TX, 78716, US

(21) Appl. No.: 09/947,013

(22) Filed: Sep. 5, 2001

(51) Int. Cl. H04N 7/10; H04N 7/16

(52) U.S. Cl. 725/34; 725/35

(57) ABSTRACT

A method and apparatus for customize messaging within a cable system includes processing that begins by obtaining a user profile of a user of the cable system. The processing continues by obtaining audience specific messages that includes a desired user profile. The desired user profile indicates targeted user profiles. The processing then continues by comparing the user profile of the user with the desired user profile for an audience specific message. When the user profile sufficiently matches the desired user profile of the message, the audience specific message is added to a list of custom messages for the user.

### TECHNICAL FIELD OF THE INVENTION

This invention relates generally to cable systems and more particularly to commercial messaging within such systems.

### BACKGROUND OF THE INVENTION

As is known, cable television (CATV) is provided to millions of users across North America via cable systems. A typical cable system includes a central office, or central headend unit, a plurality of remote headend units, and a plurality of CATV receivers. A local cable provider supplies and maintains the central office, the remote headend units and the coaxial cable coupling the user CATV receivers to a remote headend unit. The user is typically responsible for purchasing or renting the CATV receiver.

In operation, the central headend unit is coupled to one or more satellite dishes to receive broadcast transmissions of network channels (e.g., NBC), private broadcasts (e.g., HBO), pay-per-view broadcast, et cetera. The central headend unit provides all of the channels it receives to each of the remote headend units via fiber optic coupling and/or some other high-speed interface. A remote headend unit provides the channels, and may also provide channel-blocking information, to the users it supports via coaxial cable. The channel-blocking information is processed by the CATV receiver to “block” reception of unsubscribed to channels. Accordingly, the CATV receiver provides the subscribed-to channels to the user, while blocking (e.g., scrambling) the channels the user has not subscribed to.

As part of the operation of a cable system, the central headend unit and the remote headend units process national and/or local commercial messaging. Such commercial messaging may be received as part of a broadcast and passed onto the users. Alternatively, the cable system may include a database of messages that is accessed when commercials are to be presented to the users.

In such a cable system, the same commercial messages, whether local or national, are provided to the users. In other words, each user of the cable system receives the same generic, national and/or local commercial messages as every other user of the cable system. Since the users of the cable system have diverse interests, income levels, et cetera, the generic commercial messages are being provided to many users that have no interest and/or lack the means to purchase the items being advertised. Accordingly, the value of advertising to such users is minimal.

Therefore, a need exists for a method and apparatus that allows a cable system to customize messaging for users based on user profiles.

### BRIEF DESCRIPTION OF THE DRAWINGS

FIG. 1 illustrates a schematic block diagram of a cable system that includes processing in accordance with the present invention;

FIG. 2 illustrates a graphical representation of a cable program prior to customization in accordance with the present invention;

FIGS. 3 and 4 illustrate a graphical representation of an embodiment for customizing messaging in accordance with the present invention;

FIGS. 5 and 6 illustrate a graphical representation of an alternate embodiment of customizing messaging in accordance with the present invention;

FIG. 7 illustrates a logic diagram of a method for customizing messaging within a cable system in accordance with the present invention;

FIG. 8 illustrates a logic diagram of further customizing messaging in a cable system in accordance with the present invention;

FIG. 9 illustrates a logic diagram of providing specific messaging of FIG. 7 or 8 in accordance with the present invention;

FIG. 10 illustrates a logic diagram of a method for customized messaging within a cable system in accordance with the present invention; and

FIG. 11 illustrates a logic diagram of a method for end user equipment to customize messaging in a cable system in accordance with the present invention.

### DETAIL DESCRIPTION OF A PREFERRED EMBODIMENT

Generally, the present invention provides a method and apparatus for customizing messaging within a cable system. Such a method and apparatus includes processing that begins by obtaining a user profile of a user of the cable system. The user profile includes specific information regarding a user such as, but is not limited to, income level, interests, Internet purchases, credit card purchases, user provided information, and other publicly accessible information regarding a user's purchasing habits, interests, et cetera. The processing continues by obtaining audience specific messages that includes a desired user profile. The desired user profile indicates targeted user profiles and may specify income level, purchasing habits, interests, et cetera.

The processing then continues by comparing the user profile of the user with the desired user profile for an audience specific message. When the user profile sufficiently matches the desired user profile of the message, the audience specific message is added to a list of custom messages for the user. The comparison will be sufficient if at least some of the users profile information is within ranges of the desired user profile. For example, if the users income level is within or above a desired user profile income level, the comparison may be deemed to be a sufficient match. With such a method and apparatus, customized messaging within a cable system is readily achievable. Such customized messaging allows advertisers to more effectively target potential customers and allows cable systems to provide diverse messaging at simultaneous times.

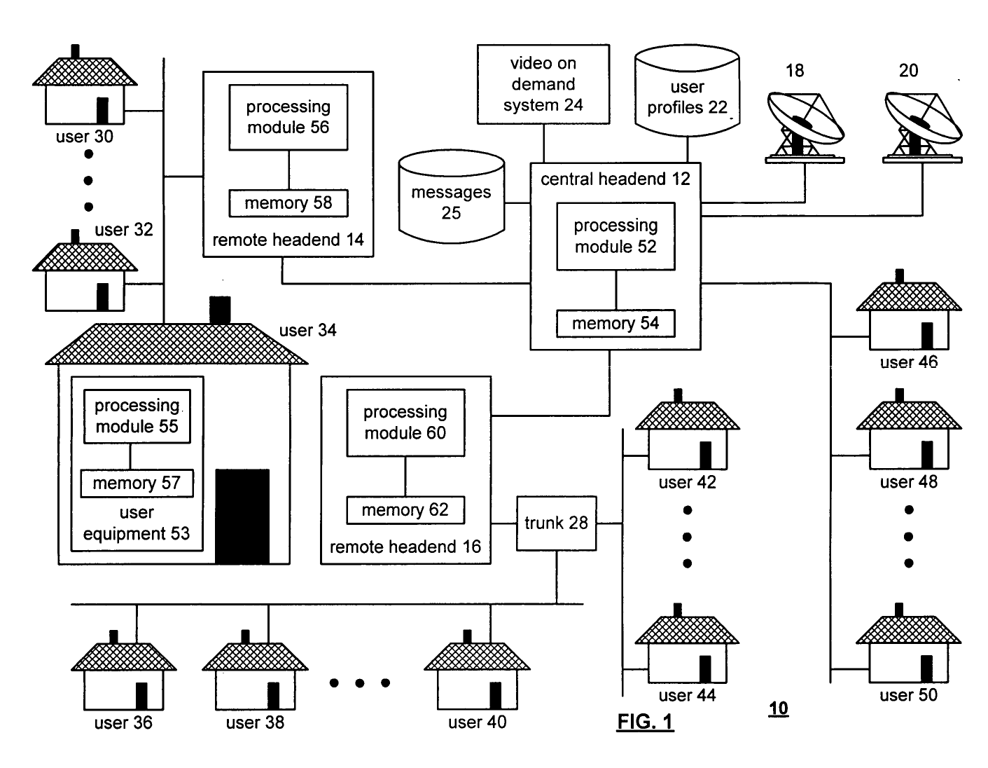

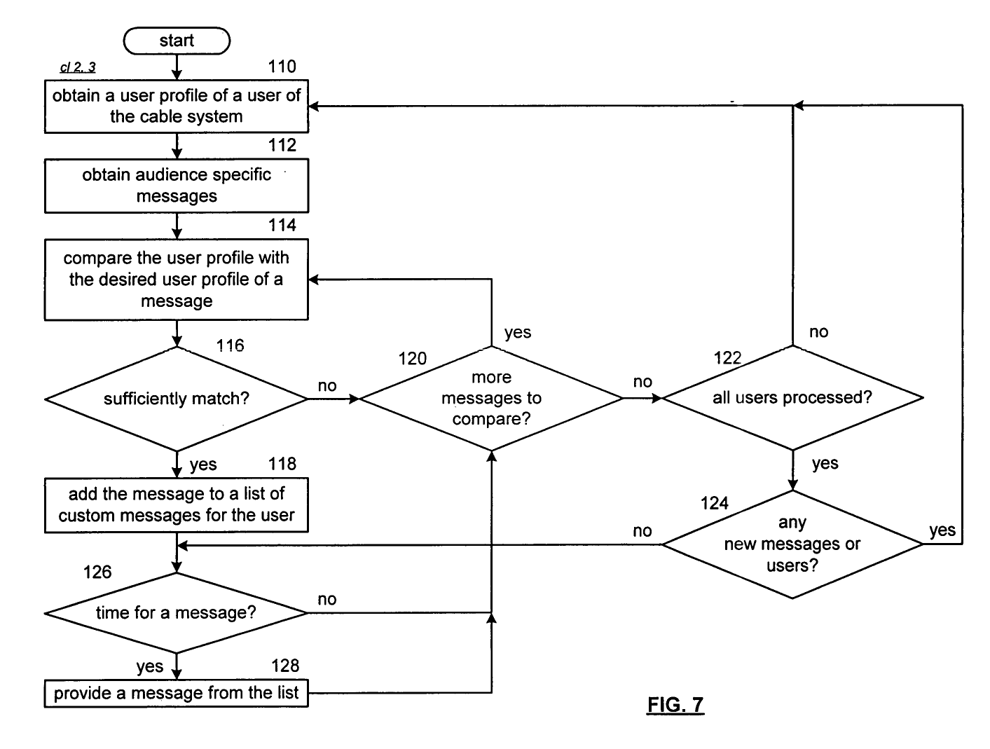

The present invention can be more fully described with reference to FIGS. 1 through 11. FIG. 1 illustrates a schematic block diagram of a cable system 10 that includes a central headend 12, a plurality of remote headend units 14 and 16, a plurality of satellite dishes 18 and 20, a user profile database 22, a video-on-demand system 24, a database of messages 25, a trunk switch 28, and a plurality of users 30-50. Each user 30-50 includes user equipment 53, which may be a cable television receiver, satellite dish receiver, set-top box, et cetera. The user equipment 53 includes a processing module 55 and memory 57. The central headend unit 12 includes processing module 52 and memory 54. Remote headend unit 14 includes processing module 56 and memory 58. Remote headend unit 16 includes processing module 60 and memory 62. Each of the processing modules 52, 55, 56 and 60 may be an individual processing device or a plurality of processing devices. Such a processing device may be a microcontroller, microcomputer, microprocessor, digital signal processor, central processing unit, programmable gate array, logic circuitry, state machine, digital signal processor, and/or any device that manipulates signals (analog and/or digital) based on operational instructions. The memory 54, 57, 58 and 62 may be a single memory device or a plurality of memory devices. Such a memory device may be volatile memory, non-volatile memory, static memory, dynamic memory, read-only memory, random access memory, and/or any device that stores digital information. The memories 54, 57, 58 and 62 store operational instructions that, when executed by the corresponding processing modules 52, 55, 56 and 60 causes the processing module to implement one or more of the processing steps illustrated in FIGS. 7 through 11.

In operation, the central headend unit 12 receives broadcast signals from satellite dishes 18 and 20. The central headend unit 12 provides the channel data to the remote headend units 14 and 16 and also to a group of users 46-50. As such, the central headend unit 12 may function as the local headend unit for users 46-50. Remote headend unit 14 supports users 30-34. Remote headend unit 16, via trunk switch 28, supports users 36-40 and users 42-44. The central headend unit 12 and the remote headend units 14-16 function in a known manner when providing cable signals of programs to the users. When the central headend unit 12 and/or the remote headend units 14 and 16 are to provide commercial messages are to provide commercial messages to one or more users, the headend units 12, 14 and 16 function in accordance with the present invention.

As shown, the central headend unit 12 is operably coupled to a user profile database 22, a message database 25 and a video-on-demand system 24. As one of average skill in the art will appreciate, the video-on-demand system 24, the user profile database 22 and the message database 25 may be distributed within the cable system 10 amongst the remote headend units 14 and 16 and the central headend unit 12. As one of average skill in the art will further appreciate, each headend unit 12-16 may include a user profile database containing user profile information of the users it supports, its own video-on-demand system and/or its own messaging database.

The messaging database 25 may include commercial messages where at least some of the commercial messages are audience specific commercial messages. Such an audience specific commercial message may target a group of users having like income brackets, interests, purchasing habits, and/or other common traits. For example, a commercial regarding car sales may be first grouped into types of cars such as luxury cars, sport utility vehicles, economy cars, mid-size cars, et cetera. Thus, when it is time to provide a message to a user, if the user profile falls within the criteria for receiving the luxury car commercial message, the users will receive the luxury car commercial. If the user falls within the economy car user profile, the user will receive the economy car commercial. Thus, at the same commercial break within a program, multiple diverse commercials may be provided simultaneously to the users based on the user profile.

Alternatively, or in addition to, the audience specific commercial messages may be customized for each individual user. For example, once the commercials have been categorized based on user profiles, the commercial may further be customized for the individual user. For example, if a user is to receive the luxury car commercials, and the users favorite color is blue, the appearance of the cars in the commercial may be blue and/or other features in the commercial may be colorized to be more appealing to the customer.

As yet another alternate, a generic commercial message may be customized for individual users based on the user profile. For example, if a generic commercial message is regarding a credit card, the user profile may be used to further customize the message. Accordingly, the user profile would be accessed to determine an individual's income level, credit rating, et cetera. From this information, the credit card commercial is customized for the individual user. For example, based on the user's profile, the user may be able to receive a platinum card with a maximum credit limit. As such, the commercial is customized to inform the user that he/she may receive a platinum card, with the allotted credit limit, and further given instructions on how to obtain the credit card. Alternatively, another user may receive a regular credit card with a substantially smaller credit limit and given instructions on how to activate that credit card.

The database of messages 25 may store the desired user profile of a particular commercial without storing the video and/or audio content of the commercial. As such, when the central headend unit identifies a particular commercial, it accesses the database to determine whether the commercial is to be customized for a group of users and/or for an individual user. The database of messages 25 may further include customizing information that indicates how the commercial is to be customized. For example, the customizing information may include the colorization of particular items in the commercial (e.g., pixel information of the item that includes color, graphical coordinates, texture map coordinates, etc., as needed), background music based on the users desired music likes, et cetera.

As an alternate mechanism for customizing messages, an advertiser may sponsor a particular program supplied by the video-on-demand system and/or pay-per-view system. For example, an advertiser may sponsor a pay-per-view program such that advertising associated with the pay-per-view program is customized for the individual advertiser as well the users. As a further extension of the sponsorship, the individual users may be given options as to how and/or if they want to receive the customized commercial messaging of the sponsor. Accordingly, based on the level of commercial acceptance by the user, the cable system 10 may charge various billing rates for viewing the sponsored pay-per-view program. For example, a user may choose not to receive any commercials at all and pay a premium for viewing the pay-per-view program (e.g., at the beginning of the program, the user receives a message that the program is sponsored by the sponsor), the user may pay a typical price and receive a typical amount of commercial advertising, and/or may pay a relatively small amount and have the pay-per-view program presented with a commercial overlay and/or other intensive commercial messaging.

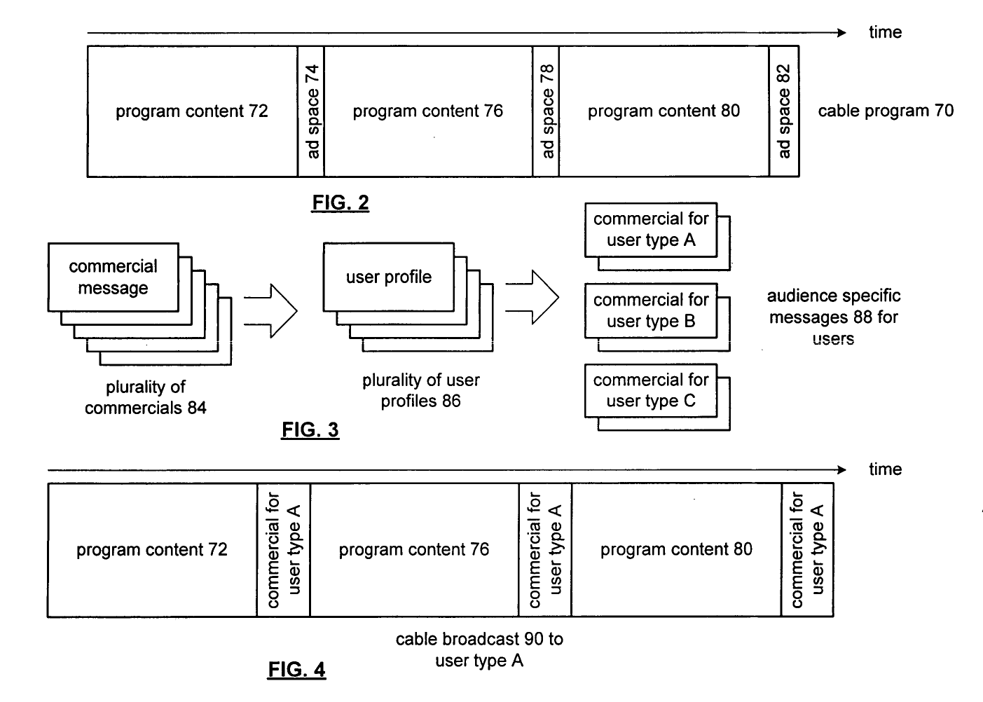

FIG. 2 illustrates a graphical diagram of a cable program 70 being provided to a plurality of users. The program 70 includes program content 72, 76 and 80 separated by ad space timing 74, 78 and 82. The graphical representation is shown with respect to time. As such, as time progresses, the program content 72 is displayed until a predetermined time duration elapses. Once the time elapses, commercial messages are provided during the ad space 74 times. During the ad space times 74, 78 or 82, the commercial messages may be customized and provided to groups of users and/or further customized for individual users.

FIGS. 3 and 4 illustrate one example of customizing messages for groups of users. As shown in FIG. 3, a plurality of commercials 84 are compared with a plurality of user profiles 86. Based on the user profiles, the commercials 84 are grouped into audience specific messages 88. As such for user types A, a listing of audience specific messages is made, as well as for user types B and user types C. The comparison of the commercials 84 with the user profiles 86 is done based on a desired user profile associated with each of the commercials 84. For example, the desired user profile may correspond to a certain income level normally associated with persons who drive luxury vehicles. As such, the comparison of the desired user profile with the user profiles is done to identify the users having the requisite income levels. For each user in this grouping, the luxury car commercial is placed on their customized messaging list. As one of average skill in the art will appreciate, the grouping of audience specific messaging 88 may be as fine or as coarse as desired by the operator of the cable system and/or the advertisers. For example, the audience specific messaging may be simply broken down by the income levels of the users where all commercials are grouped based on income level of the users. Alternatively, the income level, special interests, purchasing habits, et cetera of an individual user may be used to group the audience specific messages. Regardless of the categorizing criteria, a list of messages is maintained for each user type.

As shown in FIG. 4, the program content 72 is provided up until ad space 74. During ad space 74, a commercial for user type A is provided to all users that are of type A, commercials for user type B are provided to users of type B and commercials for user type C are provided to users that are type C. Once the ad space 74 ends, the cable broadcast 90 continues by transmitting program content 76 to all users. At the next ad space interval 78, the customized messages for user types A, B and C are provided to users that are of that type. As such, during the ad spaces 74, 78 and 82, custom messages are provided to groups of users and/or individual users based on the profiles of such users and the desired audiences of the commercial messages.

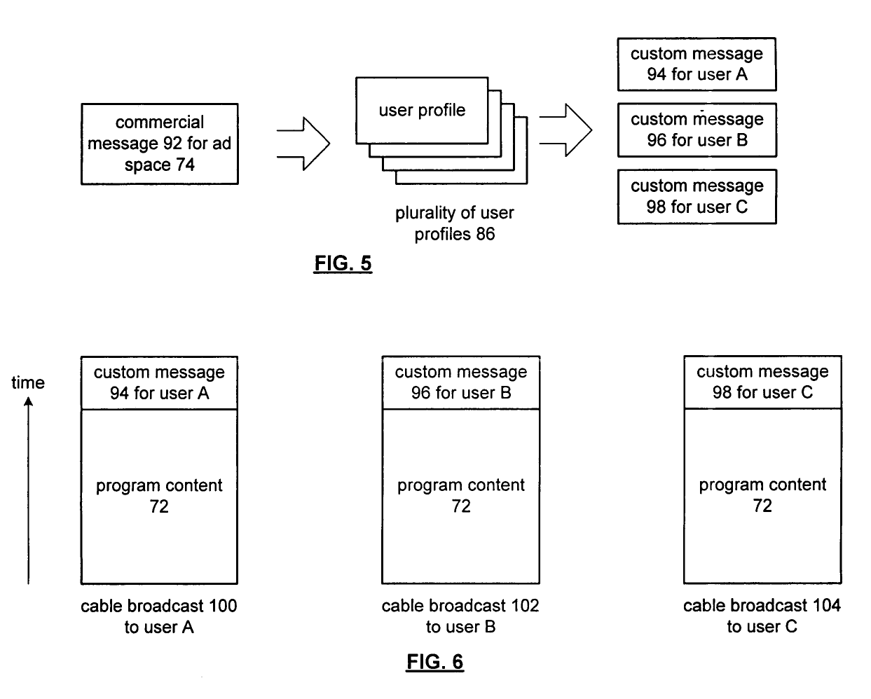

FIGS. 5 and 6 illustrate an alternate example of customizing messages for individual users. As shown in FIG. 5, a commercial message 92 for ad space 74 is processed based on a plurality of user profiles 86. The commercial message 92 may be from the plurality of commercials 84 and/or from a grouping of audience specific messages 88. Based on the user profile 86, a commercial message 92 may be customized for an individual user. As shown, custom message 94 is generated for user A, custom message 96 is generated for user B, and custom message 98 is generated for user C. The customizing of an individual message 94-98 may be to provide specific information for the individual user. For example, the message may include audio modifications wherein the individual user is addressed by name. Alternatively, video aspects of the commercial may be altered based on the color preferences, fashion preferences, et cetera of the user. As yet a further example, the message may be customized to provide individual financing information for the user based on the user's financial needs, credit history, et cetera.

For individual custom messaging, the customizing information may be provided to the user equipment 53. Such user equipment 53 may further include a multimedia system that distributes and/or processes video data, audio data and/or text data within a user's premises. Such a multimedia system is incorporated herein and described in co-pending patent application entitled METHOD AND APPARATUS FOR A MULTIMEDIA SYSTEM, having a serial number of Ser. No. 09/864,524 and a filing date of May 24, 2001.

FIG. 6 illustrates separate providing of cable broadcast 100 to user A, cable broadcast 102 to user B, and cable broadcast 104 to user C, with each beginning by providing the users A, B and C with the same program content 72. At ad space 74, the custom message 94 for user A is provided in the cable broadcast 100. For user B, at ad space 74, custom message 96 is provided. For cable broadcast 104, custom message 98 for user C is provided during ad space 74. The transmission of the individual message may be done via a particular channel that is assigned to the individual user. As is known, a headend unit may support up to 500 users and a cable system may have up to 500 channels. According to the present invention, each channel is allocated to a particular user for transmitting the individual customized message to the user. The user equipment, upon receiving the customized message, would provide the message in accordance with any instructions provided along with the message. Such processing will be further described with reference to FIG. 11.

FIG. 7 illustrates a logic diagram of a method for customized messaging within a cable system. The process begins at Step 110 where a user profile of a particular user of a cable system is obtained. This may be done by accessing a user profile database which maintains user information that includes, but is not limited to, the age of the user, family status of the user, income level of the user, favorite programs, favorite types of programs, purchasing habits, personal interests, et cetera. The process then proceeds to Step 112 where audience specific messages are obtained. Each of the audience specific messages includes a desired user profile. The desired user profile provides information to target specific types of users. For instance, the desired user profile may indicate a desired income level, age, family status, purchasing habits, et cetera.

The process then proceeds to Step 114 where the user profile of a given user is compared with the desire user profile of an audience specific message. The process then proceeds to Step 116 where a determination is made as to whether the comparison of Step 114 provides a sufficient match. A sufficient match can vary depending on the granularity of the user specific messages. If the user specific message provides an income threshold as its desired user profile, then any user having an income level at or above the income threshold would produce a sufficient match. Alternatively, the desired user profile may provide an income range, age range, family status, et cetera wherein each characteristic of the user profile must fall within the range specified within the desired user profile to yield a sufficient match.

If there is not a sufficient match between the user profile and desired user profile for a message, the process proceeds to Step 120. At Step 120, a determination is made as to whether more messages of the specific messages are to be compared. If so, the process reverts to Step 114. If not, the process proceeds to Step 122. At Step 122, a determination is made as to whether all users have been processed for all messages. If not, the process reverts back to Step 110 for the next user and/or the next message for a given user.

If all of the users have been processed with respect to all of the audience specific messages, the process proceeds to Step 124 where a determination is made as to whether any new messages and/or users have been added to the cable system. If no new messages or users are added to the system, the process proceeds to Step 126, which will be described subsequently. If a new message or user is added to the system, the process reverts to Step 110. If a new message is added, each user is processed with respect to the new message. If a new user is added, the new user is processed with respect to the audience specific messages already within the system.

If, at Step 116, a sufficient match exists, the process proceeds to Step 118. At Step 118, the message is added to a list of custom messages for the individual user. As such, each user may have a list of custom messages for it. The listing may be on a group basis or an individual basis as previously described with reference to FIGS. 3 through 6.

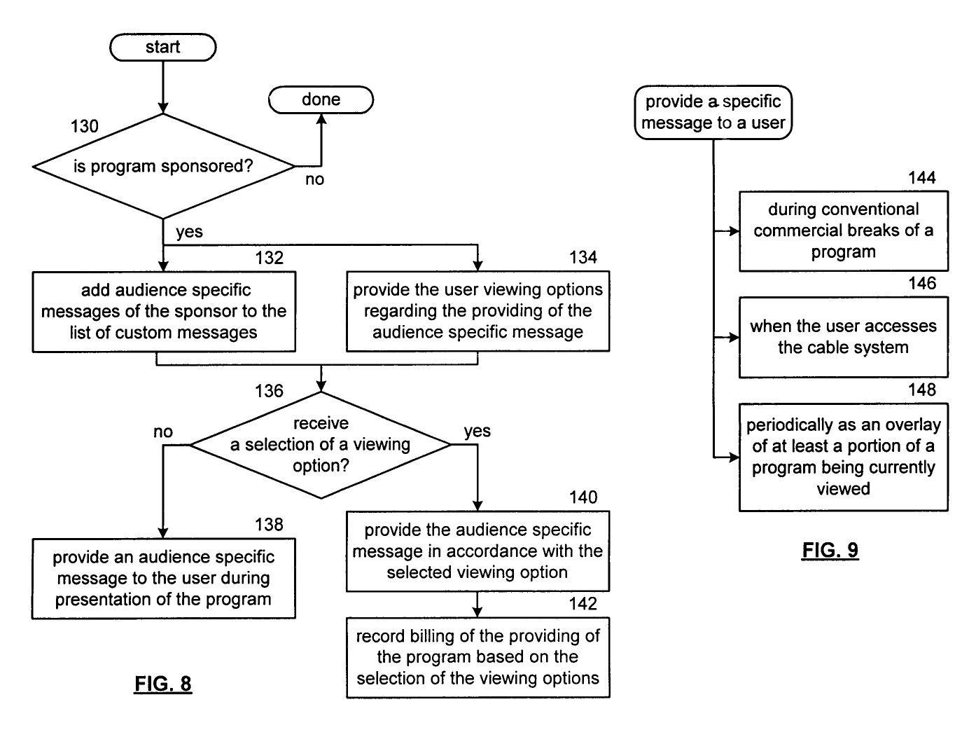

The process then proceeds to Step 126 where a determination is made as to whether a message is to be transmitted to a user or group of users. If not, the process reverts to Step 120. If a message is to be transmitted, the process proceeds to Step 128 where a message from the list of messages is provided to the users. The providing of the messages will be described in greater detail with reference to FIG. 9.

FIG. 8 illustrates a logic diagram of a method that may be done in parallel with the processing of FIG. 7. The process begins at Step 130 where a determination is made as to whether the program being viewed by a user is sponsored. If not, the process is complete with respect to sponsorship. If, however, the program is sponsored, the process proceeds to Steps 132 and 134. At Step 132, the audience specific messages of the sponsor are added to the list of custom messages for each user viewing the sponsored program. At Step 134, the user may be provided with user viewing options regarding the providing of the audience specific message. The user viewing options regarding messages include, but are not limited to, viewing the messages at typical commercial breaks, at the beginning of the program, during periodic intervals of the program, providing the commercials as a graphic overlay of the program, or providing no commercials.

The process then proceeds to Step 136 where a determination is made as to whether a selection of a viewing option has been received. If not, the process proceeds to Step 138 where the audience specific message of the sponsor is provided to the user during intervals designated for messaging.

If, however, a viewing option has been received, the process proceeds to Step 140. At Step 140, the audience specific message is provided in accordance with the selected viewing option. The process then proceeds to Step 142 where the billing of how the specific message is provided is recorded. Accordingly, the billing for the various options will be different. For example, if the user has selected no commercials, the viewing of the program may be at a premium where if the user elects to receive typical commercial insertions, the viewing of the program may be at a reduced rate or even free.

FIG. 9 illustrates a logic diagram for providing specific messages to users. Steps 144-148 may be done singularly or in combination. At Step 144, the specific message is provided during conventional commercial breaks of a program. This was illustrated with respect to FIG. 2. At Step 146, the specific messages may be routed to the user when the user first accesses the cable system. At Step 148, the messages may be provided to the user periodically as an overlay of at least a portion of the program being viewed. The overlay may be translucent or opaque.

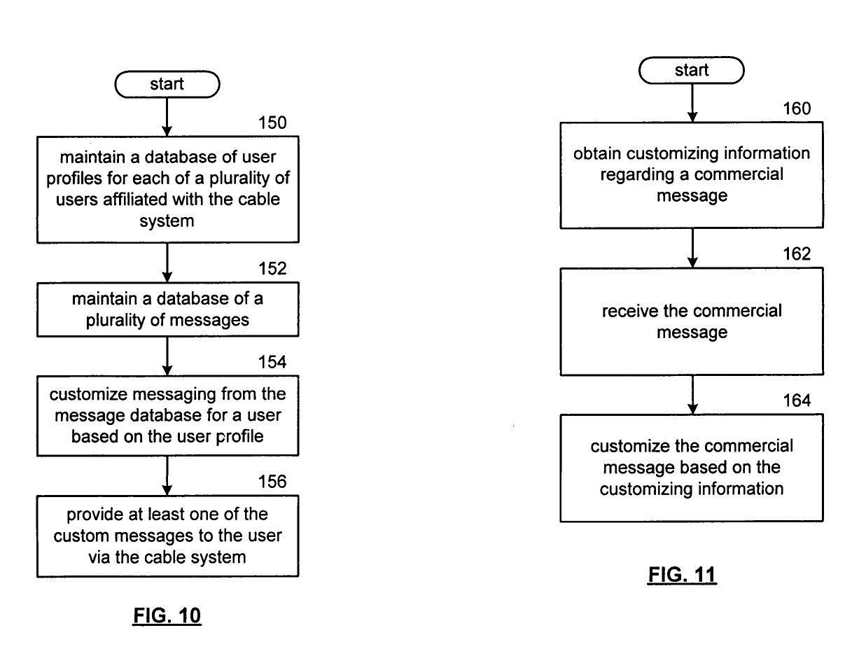

FIG. 10 illustrates a logic diagram of an alternate method for customizing messaging within a cable system. The process begins at Step 150 where a database of user profiles is maintained for each user affiliated with the cable system. The database may be maintained by the central headend unit and/or by the remote headend units. The process then proceeds to Step 152 where a database of messages is maintained. The central headend unit and/or the remote headend units may maintain the database of messages.

The process then proceeds to Step 154 where messages from the message database are customized for a particular user based on that users profile. The customizing may be done by the remote headend units and/or by the user equipment based on customizing information. The process then proceeds to Step 156 where at least one custom message is provided to a user via the cable system. This was graphically illustrated with reference to FIGS. 1 through 6.

FIG. 11 illustrates a logic diagram of an alternate method for customizing messages within a cable system. The processing of FIG. 11 may be performed by the end user equipment 53 and begins at Step 160. At Step 160, the end user equipment obtains customizing information regarding a commercial message. The customizing information may be received from the remote and/or central headend units and stored within the end user equipment. The customizing information may indicate that the color of an item in the commercial message is to be altered, the user's name is to be audibly inserted in the commercial message, and/or the special offers regarding the commercial message particular for the user are to be inserted.

The process then proceeds to Step 162 where the end user equipment receives the commercial message. The process then proceeds to Step 164 where the end user equipment customizes the commercial message based on the customizing information. This may be done by receiving an indication that the commercial message is to be customized and then subsequently customizing the message. Alternatively, the end user equipment may interpret the commercial message to determine that it is to be customized. Once the determination is made that the message is to be customized, the end user equipment customized the messages in accordance with the customizing information.

The preceding discussion has presented a method and apparatus for customizing commercial messages within a cable system. By enabling headend units to facilitate the customizing of commercials within a cable system, commercials may be more accurately directed at targeted audiences, thus providing better value to advertisers and enabling cable systems to provide commercials from multiple vendors simultaneously to more targeted audiences. As one of average skill in the art will appreciate, other embodiments may be derived from the teachings of the present invention without deviating from the scope of the claims.

What is claimed is:

1. A method for customized messaging within a cable system, the method comprises:
obtaining a user profile of a user of the cable system;
obtaining audience specific messages, wherein each of the audience specific messages includes a desired user profile;
comparing the user profile with the desired user profile for at least some of the audience specific messages; and
for each comparison where the user profile sufficiently matches the desired user profile of a message of at least some of the audience specific messages, adding the message to a list of custom messages for the user.

2. The method of claim 1, wherein the obtaining the user profile further comprises:
accessing a user database that contain a user profile for a plurality of users affiliated with the cable system.

3. The method of claim 2 further comprises:
maintaining the user profiles within the user database by maintaining at least some of: age information of the user, family status of the user, income level of the user, favorite programs, favorite types of programs, purchasing habits, and personal interests.

4. The method of claim 1 further comprises at least one of:
providing at least one of the messages on the list of custom messages to the user during conventional commercial breaks of a program;
providing the at least one of the messages on the list of custom messages to the user when the user accesses the cable system;
providing the at least one of the messages on the list of custom messages to the user periodically as an overlay of at least a portion of a program being currently viewed; and
providing customizing information regarding the at least one of the messages on the list of custom messages and the at least one of the messages on the list of custom messages.

5. The method of claim 1 further comprises:
determining whether a program being viewed by the user is sponsored by a provider of at least one of the audience specific messages;
when the program is sponsored by a provider of at least one of the audience specific messages, adding the at least one of the audience specific messages to the list of custom messages; and
providing the at least one of the audience specific messages to the user during presentation of the program.

6. The method of claim 5 further comprises:
providing the user viewing options regarding the providing of the at least one of the audience specific messages, wherein the viewing options include: at typical commercial breaks, at the beginning of the program, during periodic intervals of the program, and no providing of the at least one of the audience specific messages;
receiving a selection of one of the user viewing options;
providing the at least one of the audience specific messages in accordance with the selected one of the user viewing options; and
recording billing of the providing of the program based on the selection of the one of the user viewing options.

7. A method for custom messaging within a cable system, the method comprises:
maintaining a database of user profiles for each of a plurality of users affiliated with the cable system;
maintaining a database of a plurality of messages;
customizing messaging from the database of the plurality of messages for a user of the plurality of users based on the user profile of the user to produce custom messages; and
providing at least one of the custom messages to the user via the cable system.

8. The method of claim 7 further comprises:
maintaining, by a central headend, the database of user profiles for each of the plurality of users;
maintaining, by the central headend, the database of the plurality of messages;
providing, by the central headend, at least a portion of the database of user profiles and at least a portion of the database of the plurality of message to a remote headend;
customizing, by the remote headend, the messaging from the at least a portion of the database of the plurality of messages for the user based on the user profile of the user to produce the custom messages; and providing, by the remote headend, the at least one of the custom messages to the user.

9. The method of claim 7 further comprises:
maintaining, by a central headend, the database of user profiles for each of a plurality of users affiliated with the cable system;
maintaining, by the central headend, the database of a plurality of messages;
customizing, by the central headend, the messaging for the user to produce the custom messages;
providing, by the central headend, the custom messages to a remote headend; and
providing, by the remote headend, the at least one of the custom messages to the user.

10. The method of claim 9, wherein the providing the at least one of the custom messages to the user further comprises:
determining, by the remote headend, when to provide the at least one custom message based on message viewing options.

11. The method of claim 10 further comprises:
receiving a viewing option selection from the user to indicate the message viewing options, wherein the message viewing options include: at typical commercial breaks, at the beginning of the program, during periodic intervals of the program, and no providing of the at least one of the audience specific messages.

12. The method of claim 10 further comprises:
determining whether a program being viewed by the user is sponsored by a provider of the at least one of the custom messages;
when the program is sponsored by the provider of the at least one of the custom messages, providing the at least one of the custom messages to the user during presentation of the program.

13. The method of claim 7, wherein the customizing the messaging further comprises:
maintaining the database of the plurality of messages to include audience specific messages, wherein each of the audience specific messages includes a desired user profile;
comparing the user profile with the desired user profile for at least some of the audience specific messages; and
for each comparison where the user profile sufficiently matches the desired user profile of a message of the at least some of the audience specific messages, adding the message to a list of the custom messages for the user.

14. The method of claim 7, wherein the customizing the messaging further comprises:
inserting user specific information into a specific audience section of the at least one of the custom messages, wherein the user specific information includes at least one of: user name, type of product targeting the user, type of purchasing options for the user, and stereotypical information for a group in which the user resides.

15. An apparatus for customized messaging within a cable system, the apparatus comprises:
processing module; and
memory operably coupled to the processing module, wherein the memory includes operational instructions that cause the processing module to:
obtain a user profile of a user of the cable system;
obtain audience specific messages, wherein each of the audience specific messages includes a desired user profile;
compare the user profile with the desired user profile for at least some of the audience specific messages; and
for each comparison where the user profile sufficiently matches the desired user profile of a message of the at least some of the audience specific messages, add the message to a list of custom messages for the user.

16. The apparatus of claim 15, wherein the memory further comprises operational instructions that cause the processing module to obtain the user profile by:
accessing a user database that contain a user profile for a plurality of users affiliated with the cable system.

17. The apparatus of claim 16, wherein the memory further comprises operational instructions that cause the processing module to:
maintain the user profiles within the user database by maintaining at least some of: age information of the user, family status of the user, income level of the user, favorite programs, favorite types of programs, purchasing habits, and personal interests.

18. The apparatus of claim 15, wherein the memory further comprises operational instructions that cause the processing module to provide, at least one of:
at least one of the messages on the list of custom messages to the user during conventional commercial breaks of a program;
the at least one of the message on the list of custom messages to the user when the user accesses the cable system;
the at least one of the message on the list of custom messages to the user periodically as an overlay of at least a portion of a program being currently viewed; and
customizing information regarding the at least one of the messages on the list of custom messages and the at least one of the messages on the list of custom messages.

19. The apparatus of claim 15, wherein the memory further comprises operational instructions that cause the processing module to:
determine whether a program being viewed by the user is sponsored by a provider of at least one of the audience specific messages;
when the program is sponsored by a provider of at least one of the audience specific messages, add the at least one of the audience specific messages to the list of custom messages; and
provide the at least one of the audience specific messages to the user during presentation of the program.

20. The apparatus of claim 19, wherein the memory further comprises operational instructions that cause the processing module to:
provide the user viewing options regarding the providing of the at least one of the audience specific messages, wherein the viewing options include: at typical commercial breaks, at the beginning of the program, during periodic intervals of the program, and no providing of the at least one of the audience specific messages;
receive a selection of one of the user viewing options;
provide the at least one of the audience specific messages in accordance with the selected one of the user viewing options; and
record billing of the providing of the program based on the selection of the one of the user viewing options.

21. An apparatus for custom messaging within a cable system, the apparatus comprises:
processing module; and
memory operably coupled to the processing module, wherein the memory includes operational instructions that cause the processing module to:
maintain a database of user profiles for each of a plurality of users affiliated with the cable system;
maintain a database of a plurality of messages;
customize messaging from the database of the plurality of messages for a user of the plurality of users based on the user profile of the user to produce custom messages; and provide at least one of the custom messages to the user via the cable system.

22. The apparatus of claim 21, wherein the memory further comprises operational instructions that cause the processing module to:
maintain, as a central headend, the database of user profiles for each of the plurality of users;
maintain, as the central headend, the database of the plurality of messages;
provide, as the central headend, at least a portion of the database of user profiles and at least a portion of the database of the plurality of message to a remote headend;
customize, as the remote headend, the messaging from the at least a portion of the database of the plurality of messages for the user based on the user profile of the user to produce the custom messages; and
provide, as the remote headend, the at least one of the custom messages to the user.

23. The apparatus of claim 21, wherein the memory further comprises operational instructions that cause the processing module to:
maintain, as a central headend, the database of user profiles for each of a plurality of users affiliated with the cable system;
maintain, as the central headend, the database of a plurality of messages;
customize, as the central headend, the messaging for the user to produce the custom messages;
provide, as the central headend, the custom messages to a remote headend; and
provide, as the remote headend, the at least one of the custom messages to the user.

24. The apparatus of claim 23, wherein the memory further comprises operational instructions that cause the processing module to provide the at least one of the custom messages to the user by:
determining, as the remote headend, when to provide the at least one custom message based on message viewing options.

25. The apparatus of claim 24, wherein the memory further comprises operational instructions that cause the processing module to:
receive a viewing option selection from the user to indicate the message viewing options, wherein the message viewing options include: at typical commercial breaks, at the beginning of the program, during periodic intervals of the program, and no providing of the at least one of the audience specific messages.

26. The apparatus of claim 24, wherein the memory further a comprises operational instructions that cause the processing module to:
determine whether a program being viewed by the user is sponsored by a provider of the at least one of the custom messages;
when the program is sponsored by the provider of the at least one of the custom messages, provide the at least one of the custom messages to the user during presentation of the program.

27. The apparatus of claim 21, wherein the memory further comprises operational instructions that cause the processing module to customize the messaging by:
maintaining the database of the plurality of messages to include audience specific messages, wherein each of the audience specific messages includes a desired user profile;
comparing the user profile with the desired user profile for at least some of the audience specific messages; and
for each comparison where the user profile sufficiently matches the desired user profile of a message of the at least some of the audience specific messages, adding the message to a list of the custom messages for the user.

28. The apparatus of claim 21, wherein the memory further comprises operational instructions that cause the processing module to customize the messaging by:
inserting user specific information into a specific audience section of the at least one of the custom messages, wherein the user specific information includes at least one of: user name, type of product targeting the user, type of purchasing options for the user, and stereotypical information for a group in which the user resides.

29. A method for customizing messages within a cable system, the method comprises:
obtaining customizing information regarding a commercial message;
receiving the commercial message; and
customizing the commercial message based on the customizing information.

30. The method of claim 29, wherein the obtaining the customizing information further comprises:
receiving the customizing information from a head end unit; and
storing the customizing information.

31. The method of claim 29 further comprises:
receiving an indication that the commercial message is to be customized based on the customizing information.

32. The method of claim 29 further comprises:
interpreting the commercial message to determine whether the commercial message is to be customized; and
when the commercial message to determine whether the commercial message is to be customized, customizing the commercial message based on the customizing information.

33. The method of claim 29, wherein the customizing information further comprises at least one of:
changing color of an item in the commercial message;
inserting user's name in the commercial message; and
inserting special offers regarding the commercial message to the user.

34. An apparatus for customizing messages within a cable system, the apparatus comprises:
processing module; and
memory operably coupled to the processing module, wherein the memory includes operational instructions that cause the processing module to:
obtain customizing information regarding a commercial message;
receive the commercial message; and
customize the commercial message based on the customizing information.

35. The apparatus of claim 34, wherein the memory further comprises operational instructions that cause the processing module to obtain the customizing information by:
receiving the customizing information from a head end unit; and
storing the customizing information.

36. The apparatus of claim 34, wherein the memory further comprises operational instructions that cause the processing module to:
receive an indication that the commercial message is to be customized based on the customizing information.

37. The apparatus of claim 34, wherein the memory further comprises operational instructions that cause the processing module to:
interpret the commercial message to determine whether the commercial message is to be customized; and
when the commercial message to determine whether the commercial message is to be customized, customize the commercial message based on the customizing information.

38. The apparatus of claim 34, wherein the memory further comprises operational instructions that cause the processing module to customize the commercial message by at least one of:
changing color of an item in the commercial message;
inserting user's name in the commercial message; and
inserting special offers regarding the commercial message to the user.
